(19) United States
(12) Patent Application Publication
(10) Pub. No.: US 2024/0405247 A1
(43) Pub. Date: Dec. 5, 2024

(54) SYSTEM FOR CONDITIONING A PLURALITY OF STACKS OF HIGH-TEMPERATURE SOEC/SOFC SOLID OXIDE CELLS

(71) Applicant: COMMISSARIAT A L'ENERGIE ATOMIQUE ET AUX ENERGIES ALTERNATIVES, Paris (FR)

(72) Inventors: Julie MOUGIN, Grenoble Cedex 09 (FR); Stéphane DI IORIO, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/697,687

(22) PCT Filed: Oct. 5, 2022
(86) PCT No.: PCT/FR2022/051881

§ 371 Date: Apr. 1, 2024

(30) Foreign Application Priority Data
Oct. 5, 2021 (FR) 2110517

(51) Int. Cl. H01M 8/248; C25B 9/63; C25B 9/77; H01M 8/12; H01M 8/2404; H01M 8/2432; H01M 8/2475

(52) U.S. Cl. CPC H01M 8/248; C25B 9/63; C25B 9/77; H01M 8/12; H01M 8/2404; H01M 8/2432; H01M 8/2475; H01M 2008/1293

(57) ABSTRACT

A system for conditioning a plurality of stacks of solid oxide cells of a SOEC/SOFC type includes a thermal enclosure delimiting an internal volume, a plurality of stacks placed in the internal volume, at least two stacks being superimposed, a plurality of support devices on each of which one or more of the stacks which are not superimposed are positioned, a plurality of devices for applying compressive force to one or more of the stacks, and means for moving the plurality of devices for applying the compressive force allowing an independent mechanical clamping of the stack(s) of each of the support devices.

### TECHNICAL FIELD

The present invention relates to the general field of High Temperature Electrolysis (HTE), in particular High Temperature Steam Electrolysis (HTSE), the electrolysis of carbon dioxide (CO₂), or even the high temperature co-electrolysis of steam and of carbon dioxide (CO₂).

More precisely, the invention relates to the field of high temperature Solid Oxide Electrolyser Cells (SOEC).

It also relates to the field of high temperature Solid Oxide Fuel Cells (SOFC).

Thus, more generally, the invention refers to the field of stacks of solid oxide cells of the SOEC/SOFC type operating at high temperature.

More precisely, the invention relates to a system for conditioning a plurality of superimposed stacks of solid oxide cells of the SOEC/SOFC type operating at high temperature, allowing the stacks to be conditioned simultaneously.

### PRIOR ART

In the context of a high temperature solid oxide electrolyser of the SOEC type, this concerns converting by means of an electric current, within the same electrochemical device, steam (H₂O) into dihydrogen (H₂) and into dioxygen (O₂), and/or also converting carbon dioxide (CO₂) into carbon monoxide (CO) and into dioxygen (O₂). In the context of a high temperature solid oxide fuel cell of the SOFC type, the operation is reversed to produce an electric current and heat by being supplied with dihydrogen (H₂) or other fuels such as methane (CH₄), natural gas, biogas, and with dioxygen (O₂), typically with air. For reasons of simplicity, the following description favours the operation of a high temperature solid oxide electrolyser of the SOEC type performing the electrolysis of steam. However, this operation is applicable to the electrolysis of carbon dioxide (CO₂), or even to the high temperature co-electrolysis (HTE) of steam with carbon dioxide (CO₂). In addition, this operation can be transposed to the case of a high temperature solid oxide fuel cell of the SOFC type.

In order to perform the electrolysis of water, it is advantageous to perform it at high temperature, typically between 600 and 1,000° C., because it is more advantageous to electrolyse steam than liquid water and because some of the energy required for the reaction can be provided by heat, which is less expensive than electricity.

In order to implement high temperature steam electrolysis (HTE or HTSE), a high temperature solid oxide electrolyser of the SOEC type consists of a stack of elementary units each including a solid oxide electrolysis cell, or also electrochemical cell, consisting of three anode/electrolyte/cathode layers superimposed on one another, and of interconnection plates made of metal alloys, also called bipolar plates or interconnectors. Each electrochemical cell is clamped between two interconnection plates. A high temperature solid oxide electrolyser of the SOEC type is then an alternating stack of electrochemical cells and interconnectors. A high temperature solid oxide fuel cell of the SOFC type consists of the same type of stack of elementary units. As this technology is reversible, the same stack can operate in electrolysis mode and produce hydrogen and oxygen from water and electricity, or in fuel cell mode and produce electricity from hydrogen and oxygen.

Each electrochemical cell corresponds to an electrolyte/electrode assembly, which is typically a multilayer ceramic assembly the electrolyte of which is formed by a central ion-conducting layer, this layer being solid, dense and impervious, and clamped between the two porous layers forming the electrodes. It should be noted that additional layers may exist, but which are only used to improve one or more of the layers already described.

The interconnection devices, electrical and fluidic, are electron conductors that ensure, from an electrical point of view, the connection of each electrochemical cell of elementary unit in the stack of elementary units, guaranteeing the electrical contact between a face and the cathode of a cell and between the other face and the anode of the next cell, and from a fluidic point of view, the addition of reagents and the discharge of products for each of the cells. Thus, the interconnectors ensure the functions of conveying and collecting electric current and delimit gas circulation compartments, for the distribution and/or collection.

More precisely, the main function of the interconnectors is to ensure the passage of the electric current but also the circulation of the gases within the vicinity of each cell (namely: injected steam, extracted hydrogen and oxygen for the HTE electrolysis; air and fuel of which the injected hydrogen and extracted water for an SOFC cell), and to separate the anode and cathode compartments of two adjacent cells, which are the gas circulation compartments respectively on the anode side and the cathode side of the cells.

In particular, for a high temperature solid oxide electrolyser of the SOEC type, the cathode compartment includes steam and hydrogen, the product of the electrochemical reaction, whereas the anode compartment includes a draining gas, if present, and oxygen, another product of the electrochemical reaction. For a high temperature solid oxide fuel cell of the SOFC type, the anode compartment includes the fuel, whereas the cathode compartment includes the oxidant.

In order to perform the high temperature electrolysis (HTE) of steam, steam (H₂O) is injected into the cathode compartment. Under the effect of the electric current applied to the cell, the dissociation of water molecules in vapour form is performed at the interface between the hydrogen electrode (cathode) and the electrolyte: this dissociation produces dihydrogen (H₂) gas and oxygen ions (O²⁻). The dihydrogen (H₂) is collected and discharged at the outlet of the hydrogen compartment. The oxygen ions (O²⁻) migrate through the electrolyte and recombine into dioxygen (O₂) at the interface between the electrolyte and the oxygen electrode (anode). A draining gas, such as air, can circulate at the anode and thus collect the oxygen generated in gaseous form at the anode.

In order to ensure the operation of a solid oxide fuel cell (SOFC), air (oxygen) is injected into the cathode compartment of the cell and hydrogen into the anode compartment. The oxygen from the air will dissociate into O²⁻ ions. These ions will migrate in the electrolyte from the cathode to the anode to oxidise the hydrogen and form water with a simultaneous production of electricity. In an SOFC cell, as in SOEC electrolysis, steam is situated in the dihydrogen (H₂) compartment. Only the polarity is reversed.

By way of illustration, FIG. 1 shows a schematic view showing the operating principle of a high temperature solid oxide electrolyser of the SOEC type. The function of such an electrolyser is to convert steam into hydrogen and into oxygen according to the following electrochemical reaction:

2H₂O→2H₂+O₂.

This reaction is performed electrochemically in the cells of the electrolyser. As shown schematically in FIG. 1, each elementary electrolysis cell 1 is formed of a cathode 2 and of an anode 4, placed on either side of a solid electrolyte 3. The two electrodes (cathode and anode) 2 and 4 are electron and/or ion conductors, made of porous material, and the electrolyte 3 is gastight, an electron insulator and an ion conductor. In particular, the electrolyte 3 may be an anionic conductor, more precisely an anionic conductor of O²⁻ ions and the electrolyser is then known as an anionic electrolyser, as opposed to proton electrolytes (H⁺).

The electrochemical reactions take place at the interface between each of the electron conductors and the ion conductor.

At the cathode 2, the half-reaction is as follows:

2H₂O+4e⁻→H₂+2O²⁻.

At the anode 4, the half-reaction is as follows:

2O²⁻→O₂+4e⁻.

The electrolyte 3, inserted between the two electrodes 2 and 4, is the migration site of the O²⁻ ions under the effect of the electrical field created by the potential difference imposed between the anode 4 and the cathode 2.

As illustrated between brackets in FIG. 1, steam at the inlet of the cathode may be accompanied by hydrogen H₂ and the hydrogen produced and recovered at the outlet may be accompanied by steam. Likewise, as illustrated in dotted lines, a draining gas, such as air, may additionally be injected into the inlet on the anode side to discharge the oxygen produced. The injection of a draining gas has an additional function of acting as a heat regulator.

An elementary electrolyser, or electrolysis reactor, consists of an elementary cell such as described above, with a cathode 2, an electrolyte 3, and an anode 4, and two interconnectors that ensure the electrical and fluidic distribution functions.

In order to increase the hydrogen and oxygen flows produced, it is known to stack a plurality of elementary electrolysis cells on one another by separating them by interconnectors. The assembly is positioned between two end interconnexion plates that support the electrical supplies and the gas supplies of the electrolyser (electrolysis reactor).

A high temperature solid oxide electrolyser of the SOEC type thus comprises at least one, generally a plurality of electrolysis cells stacked on one another, each elementary cell being formed of an electrolyte, a cathode and an anode, the electrolyte being inserted between the anode and the cathode.

As indicated above, the electrical and fluidic interconnection devices that are in electrical contact with one or more electrodes in general ensure the functions of conveying and collecting electric current and delimit one or more gas circulation compartments.

Thus, the function of the so-called cathode compartment is to distribute the electric current and steam as well as to recover hydrogen at the cathode in contact.

The function of the so-called anode compartment is to distribute the electric current as well as to recover the oxygen produced at the anode in contact, possibly using a draining gas.

FIG. 2 shows an exploded view of elementary units of a high temperature solid oxide electrolyser of the SOEC type according to the prior art. This electrolyser includes a plurality of elementary electrolysis cells C1, C2, of the solid oxide cell (SOEC) type, stacked alternately with the interconnectors 5. Each cell C1, C2 consists of a cathode 2.1, 2.2 and of an anode (only the anode 4.2 of the cell C2 is shown), between which an electrolyte is disposed (only the electrolyte 3.2 of the cell C2 is shown).

The interconnector 5 is a metal alloy component that ensures the separation between the cathode 50 and anode compartments 51, defined by the volumes between the interconnector 5 and the adjacent cathode 2.1 and between the interconnector 5 and the adjacent anode 4.2 respectively. It also ensures the distribution of the gases to the cells. The injection of steam into each elementary unit is carried out in the cathode compartment 50. The collection of the hydrogen produced and of the residual steam at the cathode 2.1, 2.2 is carried out in the cathode compartment 50 downstream of the cell C1, C2 after dissociation of the steam by same. The collection of the oxygen produced at the anode 4.2 is carried out in the anode compartment 51 downstream of the cell C1, C2 after dissociation of the steam by same. The interconnector 5 ensures the passage of the current between the cells C1 and C2 by direct contact with the adjacent electrodes, that is to say between the anode 4.2 and the cathode 2.1.

As the operating conditions of a high temperature solid oxide electrolyser (SOEC) are very similar to those of a solid fuel cell (SOFC), the same technological constraints are found.

Thus, the correct operation of such stacks of solid oxide cells of the SOEC/SOFC type operating at high temperature mainly requires meeting the points mentioned below.

Firstly, an electrical insulation between two successive interconnectors is necessary, otherwise the electrochemical cell will be short-circuited, and also a good electrical contact and a sufficient contact surface are necessary between a cell and an interconnector. The lowest possible ohmic resistance is sought between cells and interconnectors.

Moreover, it is necessary to have leaktightness between the anode and cathode compartments, otherwise the gases produced will recombine resulting in a reduction of yield and above all the appearance of hot spots that damage the stack.

Finally, it is essential to have good distribution of the gases both at the inlet and at the recovery of the products, otherwise there will be a loss of yield, non-uniformity of pressure and of temperature within the various elementary units, or even unacceptable degradations of the electrochemical cells.

The incoming and outgoing gases in a high-temperature electrolysis (SOEC) or fuel cell (SOFC) stack operating at high temperature can be managed by means of devices such as that illustrated with reference to FIG. 3. The device 13 thus includes cold parts PF and hot parts PC, the latter comprising the furnace floor 11, the furnace bell 10, a looped tube 12 for managing the gas inlets and outlets and the high temperature electrolysis (SOEC) or fuel cell (SOFC) stack 20.

Moreover, FIG. 4 makes it possible to illustrate an example of an assembly 80 comprising such a stack 20 and a clamping system 60 thereof. Such an assembly 80 may be such as described in the French patent application FR 3 045 215 A1.

Thus, the stack 20 includes a plurality of electrochemical cells 41 each formed of a cathode, of an anode and of an electrolyte inserted between the cathode and the anode, and a plurality of intermediate interconnectors 42 each arranged between two adjacent electrochemical cells 41. In addition, it includes an upper terminal plate 43 and a lower terminal plate 44, respectively also known as upper stack terminal plate 43 and lower stack terminal plate 44, between which the plurality of electrochemical cells 41 and the plurality of intermediate interconnectors 42 are clamped, or between which the stack is situated.

The clamping system 60 includes an upper clamping plate 45 and a lower clamping plate 46, between which the stack 20 is clamped. Each clamping plate 45, 46 includes four clamping holes 54 through which clamping rods 55, or tie rods, extend. Clamping means 56, 57, 58 are provided at the ends thereof.

In general, the stacks 20 to date have a limited number of electrochemical cells 41. Typically, the Applicant implements stacks 20 of 25 electrochemical cells 41 with 100 cm² of active surface area. The conditioning step is carried out in a unitary way, with each stack being placed alone in a conditioning bench. The cycle applied allows both the sealing step and the reduction step for the electrochemical cells 41 to be performed. The cycle ends with various electrochemical measurements for characterising the performance of the stack, before it is delivered for use.

Prior to its operation, the stack 20 must be subjected to at least one so-called reduction heat treatment step in order to give the electrochemical cells 41 their reduced form, and not their oxidised form which they initially take. This reduction step can be a thermomechanical cycle under reducing gas for the hydrogen electrode and air or a neutral gas for the oxygen electrode. Such a heat treatment step has, for example, been described in the European patent application EP 2 870 650 A1.

Moreover, the stacks 20 implemented to date generally use, at each of their stages, seals that must guarantee the leaktightness between two adjacent and separate gas circulation compartments, i.e. an anode compartment and a cathode compartment. Such seals have been described in the European patent application EP 3 078 071 A1. These seals have the particularity of requiring thermal conditioning during which they are crushed.

In addition, the contact elements, such as the layers described in the Patent application EP 2 900 846 A1 or the Nickel grates, are also crushed during thermal conditioning and during operation of the stack 20, which guarantees that they are correctly positioned. The elements that act as contact elements in the hydrogen chamber are also crushed.

In other words, during the thermal conditioning step, a stack 20 is crushed several centimetres. To date, given the relatively small number of stacked cells, crushing takes place correctly.

However, the Applicant has envisaged embodiments of stacks with a greater number of electrochemical cells, typically in excess of 25 cells. In such a case, the expected displacement when clamping the stack can lead to mechanical problems such as blockages by jamming on the guide rods. These blockages then prevent proper thermal conditioning, and consequently normal operation of the stack.

One solution to these drawbacks is to provide a stacking concept wherein several sub-stacks are assembled, by means of stiffening plates, in order to manage significant crushing. However, each sub-stack must be conditioned separately and thus a large number of stacks and sub-stacks must be produced.

However, conditioning such a stack is time-consuming and costly because heating requires energy. In addition, current devices allow only one stack or sub-stack to be conditioned at a time.

As a result, there remains a need to improve the conditioning principle for high temperature electrolysis (SOEC) or fuel cell (SOFC) stacks, particularly to condition a plurality of stacks at the same time.

### DISCLOSURE OF THE INVENTION

The aim of the invention is to remedy at least partially the needs mentioned above and the drawbacks relating to the embodiments of the prior art.

It particularly aims to produce a multiple conditioning design for a high-temperature electrolysis (SOEC) or fuel cell (SOFC) stack while maintaining controlled clamping despite the large crushing distance of the stacks.

Thus, the object of the invention, according to one of its aspects, is a system for conditioning a plurality of stacks of solid oxide cells of the SOEC/SOFC type operating at high temperature,
each stack including a plurality of electrochemical cells each formed of a cathode, of an anode and of an electrolyte inserted between the cathode and the anode, and a plurality of intermediate interconnectors each arranged between two adjacent electrochemical cells,
characterised in that the system includes:
   a thermal enclosure delimiting an internal volume,
   a plurality of stacks placed in the internal volume, at least two stacks being at least partially, particularly completely, superimposed on one another, possibly all of the stacks being at least partially, particularly completely, superimposed on one another,
   a plurality of support devices, at least partially, particularly completely, superimposed on one another, on each of which one or more stacks, which are not superimposed on one another, are positioned, particularly juxtaposed with one another, possibly at most one stack being positioned on each support device,
   a plurality of devices for applying compressive force against one or more stacks, at least partially, particularly completely, superimposed on one another,
   means for moving said plurality of devices for applying compressive force allowing independent mechanical clamping of the stack(s) positioned on each support device.

Thanks to the invention, it may thus be possible to condition a plurality of stacks at the same time, by placing them one on top of the other, possibly by groups of stacks one on top of the other, these groups of stacks particularly being juxtaposed stacks, in order to minimise the footprint of the conditioning benches, while allowing controlled mechanical clamping to be carried out independently for each stack, or each group.

The conditioning system according to the invention may further include one or more of the following features taken alone or according to any possible technical combinations.

At least two stacks may be juxtaposed on the same support device. In addition, at least one device for applying compressive force may then be shared with said at least two juxtaposed stacks.

There is no design limit to the number of stacks that can be superimposed. However, in order to take into account the acceptable height of the conditioning bench, the number of stacks can preferably be between 2 and 20.

Advantageously, the thermal enclosure can consist of a furnace floor, forming the lower horizontal wall of the thermal enclosure, of an upper horizontal wall and of side walls, together defining the internal volume.

According to one alternative embodiment, one or more support devices may be in the form of an arch particularly comprising a substantially horizontal upper arch part, on which one or more stacks are disposed, and at least two lateral arch parts are located on either side of the upper arch part and bearing directly or indirectly on the thermal enclosure, particularly the floor.

In particular, a plurality of support devices may be in the form of a plurality of nesting arches, capable of fitting together.

Furthermore, according to another alternative embodiment, one or more support devices may be in the form of a substantially horizontal shelf and supported directly or indirectly by the thermal enclosure, particularly the side walls.

In addition, the thermal enclosure may include, in its internal volume, a mechanical frame comprising a plurality of notches at various heights to variably position the support devices in the form of shelves.

Moreover, one or more devices for applying compressive force may be in the form of an arch particularly comprising an upper arch part, particularly substantially horizontal, capable of bearing directly or indirectly against one or more stacks and particularly larger than that of the stack(s), and at least two lateral arch parts located on either side or through the upper arch part, particularly in the form of clamping rods, and passing through the thermal enclosure, particularly the floor, through first holes formed therein.

In particular, a plurality of devices for applying compressive force may be in the form of a plurality of nesting arches, capable of fitting together.

Moreover, one or more devices for applying compressive force may be capable of bearing against one or more stacks by means of at least one contact element forming a ball-joint connection between the stack(s) and the corresponding device for applying compressive force.

Furthermore, each arch, in the form of which the device(s) for applying compressive force may be, may include an upper arch part, capable of bearing directly or indirectly against one or more stacks, and at least two lateral arch parts located through the upper arch part and passing through the thermal enclosure through first holes formed therein. In addition, a plurality of through-holes may be formed through the upper arch part for the passage of said at least two lateral arch parts and possibly the passage of the lateral arch parts of one or more other arches.

The means for moving said plurality of devices for applying compressive force may include a system for controlling the displacement of said plurality of devices for applying compressive force placed in a cold area below the thermal enclosure, particularly below the furnace floor.

Moreover, the system may include at least one system for supporting at least one device for applying compressive force, located in the upper part of the thermal enclosure.

In addition, the means for moving said plurality of devices for applying compressive force may include elastic return members, particularly springs, actuators and/or pistons, located outside of the thermal enclosure, particularly below the thermal enclosure in the cold part, particularly being positioned at the ends of the lateral arch parts of the devices for applying compressive force.

The means for moving said plurality of devices for applying compressive force may particularly include a crosspiece support shared by all of the elastic return members, actuators and/or pistons making it possible to impose an identical movement thereon.

The stiffness of each elastic return member may be between 0.1 N/mm and 1,000 N/mm, particularly between 1 N/mm and 20 N/mm. In addition, the length of each elastic return member may be between 0.1 m and 10 m, particularly between 1 m and 2 m.

Furthermore, another object of the invention, according to another of its aspects, is a method for clamping a plurality of stacks of solid oxide cells of the SOEC/SOFC type operating at high temperature by way of a conditioning system such as defined above, characterised in that it includes the step of moving the plurality of devices for applying compressive force by means of movement means in the direction of the plurality of stacks to allow mechanical clamping independent of the stack(s) on each support device.

The method can advantageously be implemented under a neutral gas, directly inside the stacks or by means of the thermal enclosure, which is rendered totally inert.

### BRIEF DESCRIPTION OF THE DRAWINGS

The invention may be better understood upon reading the following detailed description of non-limiting examples of implementation thereof, as well as upon examining the figures, schematic and partial, of the appended drawings, wherein:

FIG. 1 is a schematic view showing the operating principle of a high temperature solid oxide electrolyser (SOEC),

FIG. 2 is an exploded schematic view of a portion of a high temperature solid oxide electrolyser (SOEC) comprising interconnectors and cells according to the prior art,

FIG. 3 illustrates the architectural principle of a device on which a high temperature electrolysis (SOEC) or fuel cell (SOFC) stack operating at high temperature is placed,

FIG. 4 shows a perspective and top view of an example of a stack of solid oxide cells of the SOEC/SOFC type according to the prior art with a system for clamping the stack,

FIG. 5 shows, schematically in cross-section, a first example of a conditioning system in accordance with the invention for a plurality of stacks of solid oxide cells of the SOEC/SOFC type operating at high temperature,

FIG. 6 shows, schematically in cross-section, an alternative embodiment of the example of conditioning system of FIG. 5,

FIG. 7 shows, schematically in cross-section, a second example of a conditioning system in accordance with the invention for a plurality of stacks of solid oxide cells of the SOEC/SOFC type operating at high temperature,

FIG. 8 shows, schematically in cross-section, an alternative embodiment of the example of conditioning system of FIG. 7,

FIG. 9A, FIG. 9B and FIG. 9C illustrate, schematically in partial section, alternative embodiments of a device for applying compressive force for a conditioning system in accordance with the invention,

FIG. 10 shows, in partial front view, an example of alternative embodiment of device for applying compressive force for a conditioning system in accordance with the invention,

FIG. 11 illustrates, according to a sectional view (on the left) and according to a partial front view (on the right), the principle of the alternative embodiment of the device for applying compressive force of FIG. 10,

FIG. 12 illustrates, schematically in sectional view, an alternative embodiment of a thermal enclosure of a conditioning system in accordance with the invention,

FIG. 13 illustrates, schematically in sectional view, examples of means for supporting and means for moving a conditioning system in accordance with the invention,

FIG. 14 illustrates, according to a view similar to that of FIG. 8, the operating principle of the clamping method in accordance with the invention, and

FIG. 15 and FIG. 16 illustrate, according to views similar to that of FIG. 8, alternative embodiments of means for moving a conditioning system in accordance with the invention.

In all of these figures, identical references may designate identical or similar elements.

Moreover, the different parts shown in the figures are not necessarily displayed according to a uniform scale in order to make the figures easier to read.

### DETAILED DESCRIPTION OF PARTICULAR EMBODIMENTS

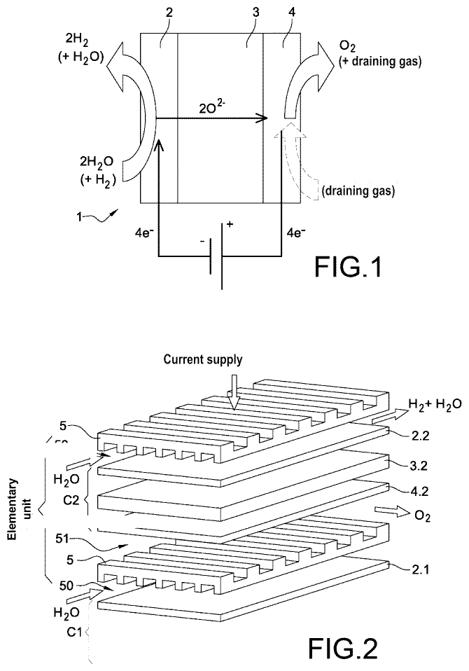

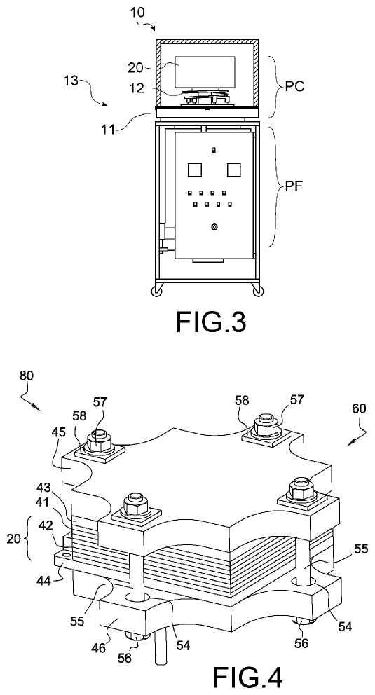

FIGS. 1 to 4 have already been described above in the part relating to the prior art and within the technical background of the invention. It is specified that, for FIGS. 1 and 2, the symbols and the arrows showing the supply of H₂O steam, the distribution and recovery of dihydrogen H₂, oxygen O₂, air and electric current, are shown for the purposes of clarity and accuracy, to illustrate the operation of the devices shown.

Furthermore, it should be noted that all component parts (anode/electrolyte/cathode) of a given electrochemical cell are preferably ceramics. The operating temperature of a high-temperature SOEC/SOFC-type stack is moreover typically between 600 and 1,000° C.

In addition, the terms “upper” and “lower” must be understood herein to be relative to the normal orientation of a stack of the SOEC/SOFC type when in the configuration of use thereof.

Examples will now be described of conditioning systems 100 in accordance with the invention for a plurality of stacks 20 of the SOEC/SOFC type with reference to FIGS. 5 to 16.

The conditioning of three stacks 20 is considered in general here. However, the number of stacks 20 is not limited by design, but rather by the fact of having to take into account the acceptable height of the conditioning bench. In addition, the number of stacks 20 is preferably between 2 and 20.

As described above in the part relating to the prior art and technical background of the invention, each stack 20 includes a plurality of electrochemical cells 41 each formed of a cathode, of an anode and of an electrolyte inserted between the cathode and the anode, and a plurality of intermediate interconnectors 42 each arranged between two adjacent electrochemical cells 41.

The three stacks 20 are placed in the internal volume Vi of a thermal enclosure 102 of the conditioning system 100. This thermal enclosure 102 here consists of a furnace floor 11, such as described above, which forms the lower horizontal wall of the thermal enclosure 102, and of an upper horizontal wall 102s and of side walls 1021, together defining the internal volume Vi, as can be seen in FIG. 5.

Advantageously, the invention makes it possible to support stacks 20 in order to place them on top of one another, this support being produced independently.

Thus, the three stacks 20 are placed in the internal volume Vi of the thermal enclosure 102 while being completely superimposed on one another.

The stacks 20 are supported by three support devices 103a, 103b and 103c, which are superimposed on one another and on each one of which a stack 20 is positioned. Here, it should be noted that, if at certain manufacturing periods, there are fewer stacks 20 to be conditioned, it is possible to use the system 100 leaving the support devices empty. In other words, the conditioning bench formed by this system 100 can operate partially.

Moreover, the system 100 also includes three devices 104a, 104b and 104c for applying compressive force to a stack 20, superimposed on one another. Each device 104a, 104b, 104c for applying compressive force may make it possible to apply a force on the stack 20 at any time and during the crushing.

The conditioning system 100 also includes means for moving, described hereinafter, the three devices 104a, 104b and 104c for applying compressive force so as to allow independent mechanical clamping of each stack 20.

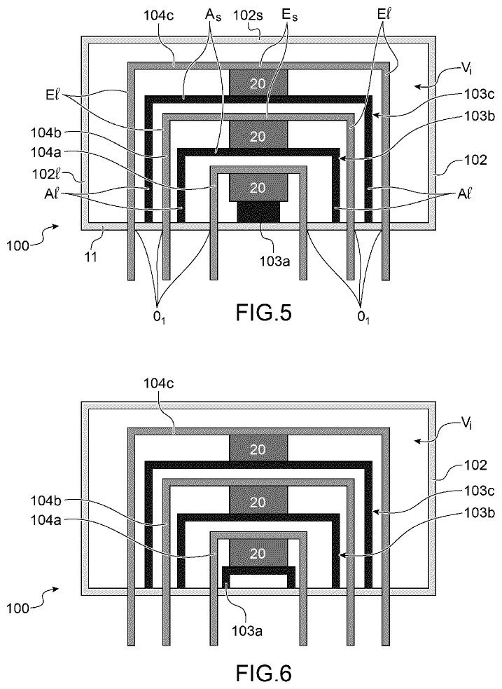

According to a first alternative embodiment that can be seen with reference to FIGS. 5 and 6, each of the three support devices 103a, 103b and 103c are in the form of an arch. More precisely, the three arches thus formed are nesting arches, capable of fitting together. As can be seen in FIG. 5, each arch 103a, 103b, 103c includes a horizontal upper arch part Aₛ on which a stack 20 is disposed, and two lateral arch parts Aₗ located on either side of the upper arch part Aₛ and bearing directly on the furnace floor 11 of the thermal enclosure 102.

It should be noted that, in FIG. 5, the support device 103a that is the lowest, the closest to the furnace floor 11, is in the form of a single foot, for example a cylinder, since nesting at this level is not necessarily required. However, in FIG. 6, this support device 103a is in the form of an arch.

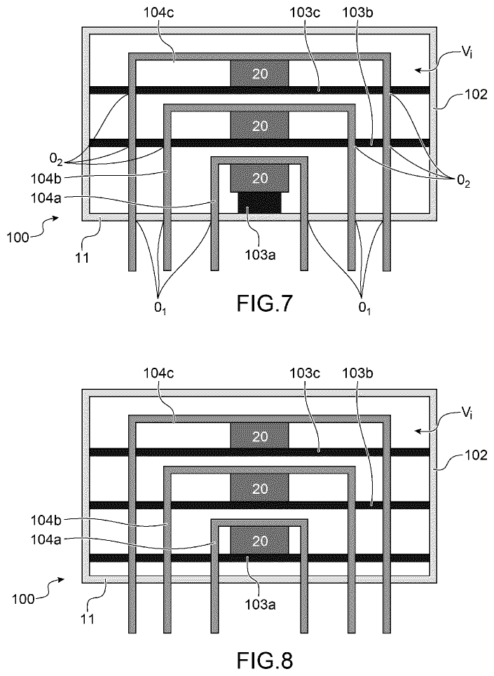

Moreover, according to the alternative embodiment of the example shown with reference to FIGS. 7 and 8, it is also possible that the three support devices 103a, 103b and 103c are in the form of a horizontal shelf and supported directly by the side walls 1021 of the thermal enclosure 102.

As above, it may be possible to form the support device 103a that is the lowest, the closest to the furnace floor 11, in the form of a single foot, for example a cylinder, as can be seen in FIG. 7. However, in FIG. 8, this support device 103a is in the form of a shelf.

In any case, the support devices 103a, 103b and 103c are advantageously locked in top position (without compression) to allow stacks 20 to be installed prior to the start of the clamping operation.

It should be noted that, if over time, the size of the stacks 20 to be conditioned changes in terms of height upwardly or downwardly, it may be possible to adjust the height of the spaces left for placing these stacks 20, either by extending or shortening the height of the lateral arch parts Aₗ, or by shifting the shelves. In the latter case, it is for example possible to implement a plurality of positioning guide rails, such as refrigerator or domestic oven shelves.

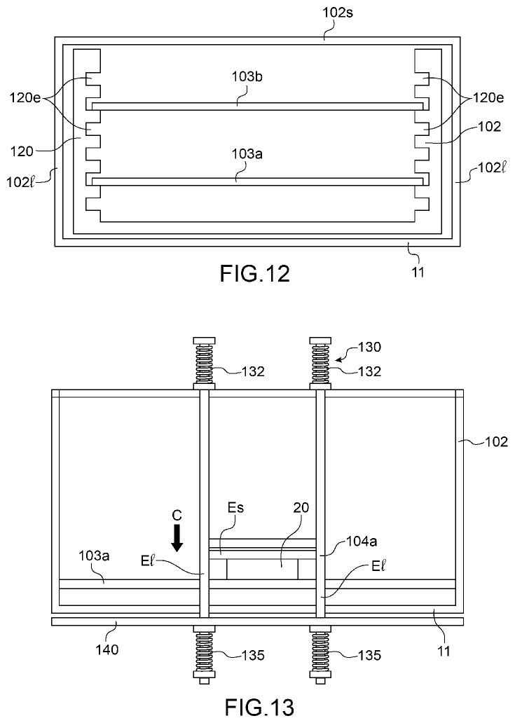

Such an example is for example described with reference to FIG. 12. Thus, the thermal enclosure 102 includes for example, in its internal volume Vi, a mechanical frame 120 that comprises a plurality of notches 102e at various heights for variably positioning the support devices 103a, 103b, 103c here in the form of shelves, which are drilled for the passage of the clamping rods described hereinafter.

Moreover, in the two examples of FIGS. 5 and 6, and of FIGS. 7 and 8, the three devices 104a, 104b and 104c for applying compressive force are in the form of an arch. As can be seen in FIG. 5, each arch includes a horizontal upper arch part Eₛ, capable of bearing directly against a stack 20 larger than that of the stack 20, and two lateral arch parts Eₗ located on either side of the upper arch part Eₛ. The lateral arch parts Eₗ may be in the form of clamping rods. In addition, the lateral arch parts Eₗ pass through the floor 11 of the thermal enclosure 102 through first holes O₁ formed therein.

Advantageously, the arches formed by the three devices 104a, 104b, 104c for applying compressive force are nesting arches, capable of fitting together.

Thus, each stack 20 is associated with an independent device 104a, 104b, 104c for applying compressive force. The force is applied on the top part of each stack 20.

The lateral arch parts Eₗ pass through the floor 11 by means of first holes O₁ but also the support devices 103a, 103b, 103c in the form of shelves, in the example of FIGS. 7 and 8, by means of second holes O₂ formed in these shelves.

The upper arch part Eₛ of each device 104a, 104b, 104c for applying compressive force may be in the form of a plate. It may be larger than that of the stack 20 in order to apply a force over the entire surface of the stack 20. Its thickness must be sufficient to prevent its deformation. It may be several centimetres. It may be made of one or more materials that are mechanically resistant at high temperature. By way of example, nickel-based alloys, for example of the Inconel® or Haynes® 230 type, may be used, high-resistance steels or also ceramics. It should be noted that the material/thickness pair must be chosen so as to be able to withstand bending.

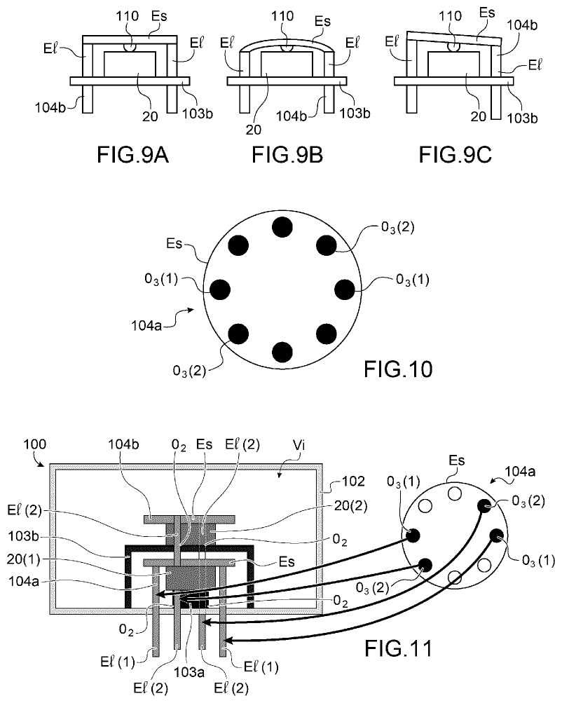

In order to minimise the consequences of any bending of the upper arch part Eₛ and an alignment defect, the installation of a ball-joint connection may be advantageous as illustrated with reference to FIGS. 9A, 9B and 9C.

Thus, each device 104a, 104b, 104c for applying compressive force (the device 104b is illustrated here) is capable of bearing against a stack 20 by means of a contact element 110 forming a ball-joint connection between the stack 20 and the corresponding device 104a, 104b, 104c for applying compressive force. This contact element 110 may be in the form of a cylinder. It should also be noted that the alternative embodiments of FIGS. 9A, 9B and 9C differ in that the upper arch part Eₛ is respectively of horizontal flat shape, of curved shape, and of oblique or inclined flat shape.

Moreover, advantageously, it is also possible to produce all or some of the devices 104a, 104b, 104c for applying compressive force in a particular form such as illustrated with reference to FIGS. 10 and 11.

Thus for example, each device 104a, 104b for applying compressive force may be in the form of an arch comprising an upper arch part Eₛ, being in the form of an upper bearing plate of circular shape. Same is further drilled with multiple through-holes O₃ to allow the passage of lateral arch parts Eₗ in the form of clamping rods. This makes it possible to increase the compactness of the system 100 and avoid having to oversize the thickness of the upper arch part Eₛ. Indeed, the number of stacks 20 to be stacked, at constant furnace width, will only be limited by the number of through-holes O₃ of the plate Eₛ.

Precisely, in this example of FIGS. 10 and 11, the first device 104a for applying compressive force includes an upper arch part Eₛ that comprises at least two through-holes O₃(1) to allow the passage of the clamping rods E₁(1) of this first device 104a for applying compressive force, allowing the first stack 20(1) to be clamped. Advantageously, this same first device 104a for applying compressive force includes an upper arch part Eₛ that also comprises at least two through-holes O₃(2) to allow the passage of the clamping rods E₁(2) of the second device 104b for applying compressive force, allowing the second stack 20(2) to be clamped. Then, the support devices 103a and 103b include second holes O₂ allowing the passage of the clamping rods E₁(2) of the second device 104b for applying compressive force. Likewise, these clamping rods E₁(2) are capable of passing through the first 20(1) and second 20(2) stacks.

Here, it should be noted that although the examples described generally show two lateral arch parts Eₗ or clamping rods Eₗ for each device 104a, 104b, 104c for applying compressive force, i.e. two clamping rods Eₗ per stack 20, the number of lateral arch parts Eₗ per device 104a, 104b, 104c for applying compressive force may particularly be between 2 and 10, and preferably equal to 3. Here, the number of clamping rods and therefore of through-holes O₃ is particularly limited by the diameter of such clamping rods.

By way of example, for three clamping rods Eₗ per stack 20, with nine through-holes O₃ on the upper arch part Eₛ, it is possible to stack three stacks 20. With twelve through-holes O₃, it will be possible to stack four stacks 20.

The total surface area of the clamping rods Eₗ must be between 10 and 2,000 cm² with a preferable value of 400 cm². For example, for three clamping rods Eₗ, the preferable surface area is 400/3=133 cm², i.e. a diameter of 13 mm for each clamping rod.

Moreover, the lateral arch parts Eₗ may be joined to the upper arch part Eₛ, particularly by welding or screwing.

During the crushing of the stack 20, the upper arch part Eₛ is in contact with the top of the stack 20 and remains in contact therewith, then descends with the stack 20 in order to maintain the force at any time. The displacement of this upper arch part Eₛ is performed by means of movement means.

In particular, these movement means comprise a system for controlling the displacement of the devices 104a, 104b, 104c for applying compressive force, which is placed in the cold area below the floor 11 of the thermal enclosure 102.

Moreover, as can be seen in FIGS. 13, 15 and 16, the movement means may also include elastic return members, here springs 135, actuators and/or pistons, which allow the mechanical compression of the stacks 20 to be performed independently.

These springs 135 are located outside of the thermal enclosure 102, below same in the cold part. They are positioned at the ends of the lateral arch parts Eₗ of the devices 104a, 104b, 104c for applying compressive force.

The rigidity of the springs 135 can be adapted to have a low effect of thermal expansions of the clamping rods Eₗ on the stack 20. In addition, it may be possible to manage the thermal expansions to make it possible to maintain a well-centred bearing on the stack 20.

The stiffness of each spring 135 is for example between 0.1 N/mm and 1,000 N/mm, and preferably between 1 N/mm and 20 N/mm. In addition, the length of each spring 135 is for example between 0.1 m and 10 m, and preferably between 1 m and 2 m.

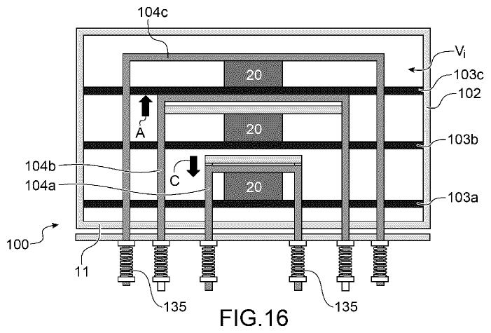

Moreover, FIG. 16 illustrates an alternative embodiment wherein the movement means also include a crosspiece support 140, in the form of a plate, shared by all of the springs 135 making it possible to impose thereon an identical movement. Such a crosspiece support 140 can also be seen in FIG. 13.

Thus, it is possible to commonly control all of the springs 135 by a common displacement imposed by the crosspiece support 140. The displacement is imposed by this crosspiece support 140 that applies the same displacement to all of the springs 135, the rigidity thereof being modulated according to the desired clamping level and the lengths of the clamping rods Eₗ installed in the hot part and the expected expansions.

Furthermore, as can be seen in FIG. 13, the conditioning system 100 may include a system 130 for supporting one or more devices 104a, 104b, 104c for applying compressive force (here the device 104a). Such a support system 130 is located in the upper part of the thermal enclosure 102. It consists in adding springs 132 to the ends of the clamping rods Eₗ, which are extended beyond the upper arch part Eₛ and pass through the upper horizontal wall 102s of the thermal enclosure 102.

This support system 130 makes it possible to support the upper arch part Eₛ when same is not clamped by the springs 135 at the bottom. Thus, this makes it possible to position the stack 20 easily. When the springs 135 are tightened, it is possible to apply a load on the stack 20.

Furthermore, FIGS. 13 to 16 illustrate examples of displacement of the first device 104a for applying compressive force and of the second device 104b for applying compressive force.

Thus, the arrows C show the lowering of the first device 104a during the crushing of the first stack 20 during the conditioning step. This concerns a downward displacement to assist the crushing of the stack 20 with a continuity of application of the force.

The arrows A show the placement of the device 104b in top position to allow the second stack 20 to be installed prior to the start of the conditioning step.

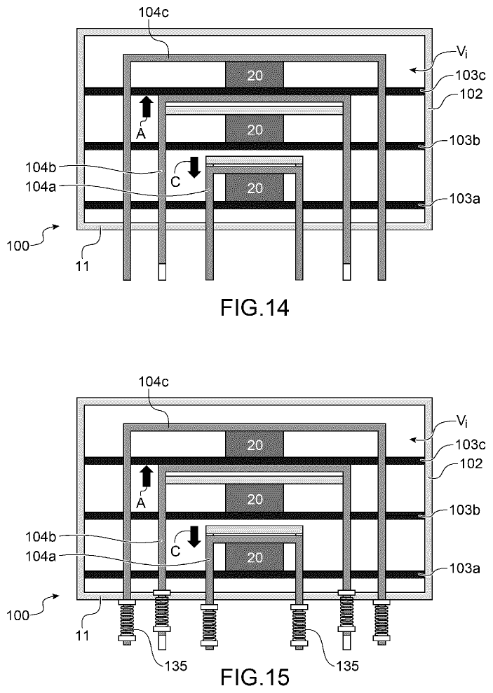

In FIGS. 14, 15 and 16, the third stack 20 at the top is illustrated in a reference position, simply installed and before crushing.

The conditioning may be performed under a neutral gas, either via the inside of the stacks 20, or in the completely inserted thermal enclosure 102. In such a case, the system 100 may include a sealed inner muffle and the junction between the clamping rods and the muffle may be produced by a bellows.

Of course, the invention is not limited to the examples of embodiments that have just been described. Various modifications may be made thereto by a person skilled in the art.

1-15. (canceled)

16. A system for conditioning a plurality of superimposed stacks of solid oxide cells of a SOEC/SOFC type operating at a high temperature, comprising:
a thermal enclosure delimiting an internal volume;
the plurality of stacks placed in the internal volume, at least two stacks being at least partially superimposed on one another, each of the plurality of superimposed stacks including a plurality of electrochemical cells each formed of a cathode, an anode, and an electrolyte inserted between the cathode and the anode, and a plurality of intermediate interconnectors each arranged between two adjacent electrochemical cells of the plurality of electrochemical cells;
a plurality of support devices at least partially superimposed on one another, on each of which one or more stacks which are not superimposed on one another are positioned;
a plurality of devices for applying a compressive force to one or more stacks, at least partially superimposed on one another; and
means for moving the plurality of devices for applying the compressive force allowing an independent mechanical clamping of the stack(s) positioned on each of the plurality of support devices, the means for moving the plurality of devices for applying the compressive force including elastic return members, actuators, and/or pistons, located outside of the thermal enclosure.

17. The system according to claim 16, wherein a number of the stacks is between 2 and 20.

18. The system according to claim 16, wherein the thermal enclosure consists of a furnace floor, forming a lower horizontal wall of the thermal enclosure, an upper horizontal wall and side walls, together defining the internal volume.

19. The system according to claim 18, wherein one or more of the plurality of support devices are in a form of an arch comprising a substantially horizontal upper arch part, on which one or more of the plurality of superimposed stacks are disposed, and at least two lateral arch parts located on either side of the upper arch part and bearing directly or indirectly on the thermal enclosure.

20. The system according to claim 18, wherein one or more of the plurality of support devices are supported directly or indirectly by the side walls of the thermal enclosure.

21. The system according to claim 18, wherein one or more of the plurality of support devices are in a form of a substantially horizontal shelf and supported directly or indirectly by the thermal enclosure.

22. The system according to claim 21, wherein the thermal enclosure includes, in the internal volume, a mechanical frame comprising a plurality of notches at various heights to variably position the support devices in a form of shelves.

23. The system according to claim 16, wherein one or more of the plurality of devices for applying the compressive force are in a form of an arch comprising an upper arch part configured to bear directly or indirectly against one or more of the plurality of superimposed stacks, and at least two lateral arch parts located on either side or through the upper arch part and passing through the thermal enclosure, through first holes formed therein.

24. The system according to claim 23, wherein the at least two lateral arch parts comprise clamping rods passing through a floor of the thermal enclosure.

25. The system according to claim 23, wherein
each arch includes the upper arch part, configured to bear directly or indirectly against the one or more of the plurality of superimposed stacks, and the at least two lateral arch parts located through the upper arch part and passing through the thermal enclosure through the first holes formed therein, and
a plurality of through-holes is formed through the upper arch part for passage of the at least two lateral arch parts.

26. The system according to claim 23, wherein the elastic return members, the actuators, and/or the pistons are positioned at ends of the lateral arch parts of the plurality of devices for applying the compressive force.

27. The system according to claim 16, wherein one or more of the plurality of devices for applying the compressive force are configured to bear against one or more of the plurality of superimposed stacks by means of at least one contact element forming a ball-joint connection between the stack(s) and a corresponding one of the plurality of devices for applying the compressive force.

28. The system according to claim 16, wherein the means for moving the plurality of devices for applying the compressive force includes a system for controlling a displacement of the plurality of devices for applying the compressive force placed in a cold area below the thermal enclosure.

29. The system according to claim 16, further comprising at least one system for supporting at least one of the plurality of devices for applying the compressive force, located in an upper part of the thermal enclosure.

30. The system according to claim 29, wherein the means for moving the plurality of devices for applying the compressive force includes a crosspiece support shared by all of the elastic return members, the actuators, and/or the pistons making it possible to impose an identical movement on the elastic return members, actuators and/or the pistons.

31. The system according to claim 16, wherein the elastic return members, the actuators, and/or the pistons are located below the thermal enclosure in a cold area.

32. A method for clamping a plurality of stacks of solid oxide cells of a SOEC/SOFC type operating at a high temperature using the conditioning system according to claim 16, comprising:
moving the plurality of devices for applying the compressive force using the means for moving in a direction of the plurality of stacks to allow the independent mechanical clamping of the stack(s) on each of the plurality of support devices.

33. The method according to claim 32, wherein the method is implemented under a neutral gas, directly inside the stacks or using the thermal enclosure, which is rendered totally inert.
